(19) United States
(12) Patent Application Publication
(10) Pub. No.: US 2006/0131926 A1
(43) Pub. Date: Jun. 22, 2006

(54) Motor vehicle door member comprising an appearance part and a structural part

(76) Inventor: Francois Virelizier, Bourgoin Jallieu (FR)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/252,318

(22) Filed: Oct. 17, 2005

(30) Foreign Application Priority Data
Oct. 15, 2004 (FR) 0410974

(51) Int. Cl. B60J 5/00

(52) U.S. Cl. 296/146.1

(57) ABSTRACT

The invention relates to a motor vehicle door member (10) comprising an appearance part constituted by an outside skin (12) of polyolefin, and a structural part (14) having a coefficient of expansion that is less than that of the skin, the two parts being united by a bead of adhesive placed on a face of one of the two parts facing a face of the other part. The adhesive presents: breaking elongation lying in the range 20% to 800%; purely elastic elongation over a fraction of its breaking elongation; and Young's modulus lying in the range 0.5 MPa to 300 MPa. After bonding, the bead of adhesive presents a nominal thickness lying in the range 0.8 mm to 3 mm.

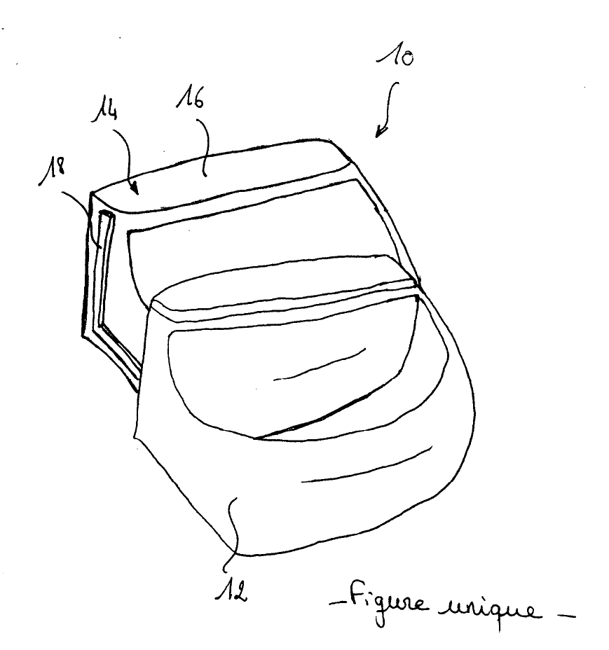

### TECHNICAL FIELD

The invention relates to motor vehicle door members made of plastics material, constituted by assembling together an appearance part and a structural part.

### STATE OF THE ART

Door members, in particular tail-gates, are known, they are constituted by assembling together an intermediate metal frame, an outside panel, or outside skin, made of PCPBT plastics material (sold by the supplier General Electric Plastics under the trademark Xenoy), and an inside panel forming a structural part in the form of a box, e.g. made of a thermosetting bulk molding compound (BMC) material, the two panels being bonded together by a bead of adhesive that is at most 1 millimeter (mm) thick.

### PROBLEM POSED BY THAT STATE OF THE ART

The two plastics material panels have coefficients of thermal expansion (also referred to as coefficients of linear thermal expansion CLTE) that are very different (with that of the outside skin being 4 times to 10 times greater than that of the structural part) thus leading to high levels of tension in the bead of adhesive, in the event of the temperature of the door member rising, in particular during tests of exposure to sunshine and heat. The bead of adhesive then does not deform sufficiently to absorb the geometrical offsets generated by the expansion, leaving marks on the less rigid part, i.e. the part having the smaller Young's modulus. Conversely, the elasticity of the bead of adhesive, also referred to as remanence, is not sufficient to enable it to return to its initial shape on cooling, such that the appearance of the assembly comprising the two panels is deteriorated by the return from expansion that takes place during cooling. Linear marks can then be seen in register with the bead in the less rigid part, i.e. the outside skin.

The invention seeks to provide a door member comprising an outside panel of polyolefin and a structural panel that are bonded together by adhesive, but without the adhesive creating visible defects in the outside panel.

### SOLUTION PROPOSED BY THE INVENTION

The invention provides a door member comprising an appearance part constituted by an outside skin of polyolefin, and a structural part having a coefficient of expansion that is smaller than that of the skin, the two parts being bonded together by a bead of adhesive deposited on one of the facing faces of the two parts, the adhesive presenting:
breaking elongation lying in the range 20% to 800%;
purely elastic elongation over a fraction of its breaking elongation; and
Young's modulus lying in the range 0.5 megapascals (MPa) to 300 MPa;
   and after bonding the bead of adhesive presents a nominal (or mean) thickness lying in the range 0.8 mm to 3 mm.

By this combination of characteristics for the adhesive, a polyolefin panel and a panel made of a more rigid material can be adhesively bonded together without the expansion of the bonded polyolefin leading to marks in its surface. The structural part is preferably made of a composite material, comprising a resin and an additive. The part may be thermosettable, in particular a polyester that is particularly suited to the automobile field, bulk molding compound (BMC), or sheet molding compound (SMC). The structural part can also be constituted by a reinforced thermoplastic, in particular a fiberglass-filled polypropylene, of the PPGFL type. Under such circumstances, it is preferable for the thermoplastic part also to be reinforced by sheet metal inserts.

The polyolefin skin is preferably made of polypropylene, or of polyethylene. It generally contains 10% to 50% by weight, and preferably 20% to 40% by weight of talc.

A door member of the invention may further comprise one or more of the following characteristics:
the adhesive presents purely elastic elongation over at least 50% of its breaking elongation;
the bead of adhesive presents a nominal width of less than 25 mm;
the polyolefin has a coefficient of expansion lying in the range 20×10⁻⁶ millimeters per millimeters per kelvin (mm/mm/K) to 60×10⁻⁶ mm/mm/K, and preferably lying in the range 30×10⁻⁶ mm/mm/K to 45×10⁻⁶ mm/mm/K;
the polyolefin does not have any anti-UV additives; it has been found, surprisingly, that the bonding strength of the adhesive is greatly improved if such additives are omitted from the composition of the polyolefin;
the polyolefin contains 10% to 50% by weight of elastomeric fillers, e.g. of the EPDM type;
the polyolefin has a Young's modulus lying in the range 1000 MPa to 2500 MPa, and preferably greater than 1500 MPa;
the structural part and the skin present a Young's modulus ratio E_{struct}/Eₛₖᵢₙ (structural part Young's modulus over skin Young's modulus) lying in the range 3 to 15, which means that the structural part is more rigid than the skin;
the coefficient of expansion of the outside skin is greater than 1.5 times the coefficient of the structural part; thus, even with a skin that expands considerably relative to the structural part, the use of a bead of adhesive in accordance with the invention does not lead to any outside marks on the skin after temperature stressing;
the Young's modulus of the adhesive lies in the range 0.5 MPa to 10 MPa;
the nominal thickness of the bead of adhesive after bonding lies in the range 1.5 mm to 2 mm;
the nominal width of the bead of adhesive after bonding is less than 12 mm;
the nominal thickness of the polyolefin skin over the bead of adhesive lies in the range 1.5 mm to 4 mm; and
the structural part includes reinforcement secured thereto in conventional manner or embedded therein by overmolding.

The invention relates in particular to a rear door member, in particular a tail-gate or a trunk door.

### PARTICULAR EMBODIMENTS

The invention can be better understood on reading the following description given purely by way of example and made with reference to the sole figure, which is a diagrammatic exploded view of a door member of the invention.

A motor vehicle tail-gate 10 of the invention is constituted by an outside skin 12 of polyolefin and a structural part 14 bonded together by a bead of adhesive.

The structural part 14 comprises a panel 16 of fiberglass-filled polypropylene known as PPGF having thickness of about 3 mm, with a fiberglass fabric (not shown) as sold under the trademark Twintex, added thereto, and with an insert 18 of sheet metal acting as reinforcement. The insert 18 is made of extruded steel and is shaped so as to provide a frame around the panel 16. It is secured to a stamped portion (not shown) of the panel in conventional manner, e.g. by means of screws. Alternatively, the insert 18 could have the panel 16 overmolded thereon. The insert also serves as a support for hinges. The PPGF to which the fabric has been added presents a Young's modulus of 10,000 MPa, and a coefficient of expansion of 3.20×10⁻⁵ mm/mm/K.

The outside skin 12 is made of polypropylene filled with 20% to 30% by weight of talc, having a Young's modulus of 1800 MPa, and a coefficient of expansion of 6×10⁻⁵ mm/mm/K. It contains 10% to 50% by weight of elastomeric fillers, e.g. of the EPDM type, and it does not have any anti-UV additives. The mean thickness of the skin 12 is 3.2 mm.

The panel 16 has a coefficient of expansion that is almost half that of the skin 12. Its Young's modulus is more than 5 times greater than that of the skin 12.

In another embodiment, the skin 12 is made of the polypropylene sold by the supplier Dow Plastics under the trade reference DTF380.00SU.

In another embodiment (not shown), the structural part is a panel of thermosetting material, specifically a BMC such as that sold by the French supplier MCR under the trademark AMC 3600 (adapted molding compound). That structural part can have no reinforcement. AMC has a Young's modulus of 13,000 MPa and a coefficient of expansion of 1.70×10⁻⁵ mm/mm/K. Under such circumstances, the structural part has a Young's modulus that is more than 7 times greater than that of the skin, and a coefficient of expansion that is less than one-third that of the skin.

The two parts are united by two beads of adhesive (not shown) placed on the face of one of the parts where it faces a face of the other part, at the periphery of one of the panels 12, 16, and also at the periphery of the back window. The adhesive presents breaking elongation of 400%, with purely elastic elongation over 50% of its breaking elongation, and a Young's modulus of 5 MPa.

The nominal thickness (after bonding) of the bead of adhesive is 2 mm (it lies in the range 1 mm to 3 mm), and its nominal width is 10 mm.

1. A motor vehicle door member (10) comprising an appearance part constituted by an outside skin (12) of polyolefin, and a structural part (14) having a coefficient of expansion that is less than that of the skin, the two parts being united by a bead of adhesive placed on a face of one of the two parts facing a face of the other part, the door member being characterized in that the adhesive presents:
breaking elongation lying in the range 20% to 800%;
purely elastic elongation over a fraction of its breaking elongation; and
Young's modulus lying in the range 0.5 MPa to 300 MPa,
and in that the bead of adhesive, after bonding, presents a nominal thickness lying in the range 0.8 mm to 3 mm.

2. A door member according to claim 1, in which the structural part is made of a thermosettable polymer, in particular of bulk molding compound (BMC),

3. A door member according to claim 1, in which the structural part is made of reinforced thermoplastic polymer, in particular fiberglass filled polypropylene including a sheet of fiberglass.

4. A door member according to any one of claims 1 to 3, in which the polyolefin is a polypropylene.

5. A door member according to any one of claims 1 to 4, in which the polyolefin has a coefficient of expansion lying in the range 20×10⁻⁶ mm/mm/K to 60×10⁻⁶ mm/mm/K, and preferably lying in the range 30×10⁻⁶ mm/mm/K to 45×10⁻⁶ mm/mm/K.

6. A door member according to any one of claims 1 to 5, in which the polyolefin contains 10% to 50% by weight and preferably 20% to 40% by weight of talc.

7. A door member according to any one of claims 1 to 6, in which the polyolefin has no anti-UV additives.

8. A door member according to any one of claims 1 to 7, in which the polyolefin contains 10% to 50% by weight of elastomeric fillers, e.g. of the EPDM type.

9. A door member according to any one of claims 1 to 8, in which the polyolefin has Young's modulus lying in the range 1000 MPa to 2500 MPa, and preferably greater than 1500 MPa.

10. A door member according to any one of claims 1 to 9, in which the structural part and the skin have a Young's modulus ratio E_{struct}/Eₛₖᵢₙ (Young's modulus of the structural part/Young's modulus of the skin) lying in the range 3 to 15.

11. A door member according to any one of claims 1 to 10, in which the coefficient of expansion of the outside skin is more than 1.5 times that of the structural part.

12. A door member according to any one of claims 1 to 11, in which the Young's modulus of the adhesive lies in the range 0.5 MPa to 10 MPa.

13. A door member according to any one of claims 1 to 12, in which the nominal thickness of the bead of adhesive after bonding lies in the range 1.5 mm to 2 mm.

14. A door member according to any one of claims 1 to 13, in which the nominal width of the bead of adhesive after bonding is less than 25 mm, preferably less than 12 mm.

15. A door member according to any one of claims 1 to 14, in which the nominal thickness of the polyolefin skin over the bead of adhesive lies in the range 1.5 mm to 4 mm.

16. A door member according to any one of claims 1 to 15, in which the adhesive presents purely elastic elongation over at least 50% of its breaking elongation.

17. A door member according to any one of claims 1 to 16, in which the structural part includes reinforcement (18), secured thereto or embedded therein by overmolding.

18. A motor vehicle rear door member according to any one of claims 1 to 17, in particular a tail-gate or a trunk door.
